(19) United States
(12) Patent Application Publication
(10) Pub. No.: US 2007/0090818 A1
(43) Pub. Date: Apr. 26, 2007

(54) Control circuit of DC-DC converter and control method thereof

(75) Inventor: Eiji Nishimori, Kasugai (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/340,459

(22) Filed: Jan. 27, 2006

(30) Foreign Application Priority Data
Oct. 20, 2005 (JP) 2005-305748

(51) Int. Cl. G05F 1/00

(52) U.S. Cl. 323/282

(57) ABSTRACT

The present invention presents a DC-DC converter control circuit and a control method capable of reducing errors between an output voltage and a reference voltage due to fluctuations of an input voltage and an offset voltage of a voltage comparator. A control unit 9 includes an integrating circuit 12, a voltage comparator COMP1, and one-shot flip-flop FF1. An integrator 10 calculates an integral value of a difference between an output voltage Vout of a DC-DC converter 1 and a reference voltage Vr, and outputs an output voltage Vx. An attenuator 11 sums up the attenuated output voltage Vx and the reference voltage Vr, and outputs an adjusted reference voltage Vr′. The voltage comparator COMP1 sets a transistor FET1 in a conductive state as the output voltage Vout becomes smaller than the adjusted reference voltage Vr′. The value of the adjusted reference voltage Vr′ or a threshold voltage is controlled, so that an average output voltage Vave may coincide with the reference voltage Vr.

### CROSS-REFERENCE TO RELATED APPLICATIONS

This application is based upon and claims the benefit of priority from each of the prior Japanese Patent Application No. 2005-305748 filed on Oct. 20, 2005, the entire contents of which are incorporated herein by reference.

### BACKGROUND OF THE INVENTION

1. Field of the Invention

The invention relates to a control circuit of a DC-DC converter and a control method thereof, and more particularly to a control circuit of the DC-DC converter and a control method thereof capable of improving an error between an output voltage and a reference voltage.

2. Description of the Related Art

FIG. 6 is a diagram showing a DC-DC converter 100 of a comparator system. A voltage comparator COMP100 of a control unit 109 compares an output voltage Vout of the DC-DC converter 100 with a reference voltage Vr, and outputs a low level when the output voltage Vout is higher than the reference voltage Vr, and outputs a high level when the output voltage Vout is lower than the reference voltage Vr. A one-shot flip-flop FF100 is in a set state when a high level signal is entered in a set input terminal S, and outputs the high level signal from a non-inverting output terminal Q. After a specified time, it returns to a reset state, and outputs a low level signal from the non-inverting output terminal Q.

A related technology is disclosed in Japanese Unexamined Patent Application Nos. H10(1998)-225105, 2000-32744, 2000-287439, and H10(1998)-210734.

### SUMMARY OF THE INVENTION

However, in the DC-DC converter 100 of the comparator system, depending on an input voltage Vin or an equivalent series resistance ESR of a smoothing capacitor C100, a ripple voltage is generated in the output voltage Vout. There is a problem in that this ripple voltage causes an error between an average of the output voltage Vout and the target reference voltage Vr. Also due to the presence of an offset voltage or a circuit delay time in the voltage comparator COMP100, an error is caused between the output voltage Vout and the reference voltage Vr, which is a problem.

The present invention aims at solving at least one of the problems of the prior art. Accordingly, it is an object of the present invention to provide a control circuit of a DC-DC converter and a control method of the DC-DC converter capable of reducing errors between an output voltage and a reference voltage due to fluctuations of an input voltage, an offset voltage of a voltage comparator, and a circuit delay time and responding rapidly to sudden load changes.

To achieve the purpose above, a control circuit of a DC-DC converter of a switching regulator system for generating an output voltage depending on a first reference voltage from an input voltage, comprises: an integrating circuit for determining an integral value of a differential voltage of the output voltage of the DC-DC converter and the first reference voltage, wherein a main switching transistor is controlled depending on a comparison result of the output voltage of the DC-DC converter and an output voltage of the integrating circuit.

A first reference voltage is a target voltage value of average of an output voltage of the DC-DC converter, and is a predetermined value. An integrating circuit determines an integral value of voltage difference between an output voltage of the DC-DC comparator and the first reference voltage. By the integration, a ripple voltage of the output voltage of the DC-DC converter is averaged. Then, an error between an average of the output voltage of the DC-DC comparator and the first reference voltage is obtained.

Depending on the comparison result of the output of the integrating circuit and the output of the DC-DC converter, a switching transistor is controlled, which is known as feedback control. The output of the integrating circuit is a threshold value, and the output of the DC-DC converter intersects with the output of the integrating circuit, so that switching of the switching transistor is controlled. The output of the integrating circuit is adjusted depending on the error between the average of the output voltage of the DC-DC converter and the first reference voltage. As a result, the error between the average of the output voltage of the DC-DC converter and the first reference voltage is compensated, and the output of the integrating circuit, that is, the threshold value is controlled so that both the voltages may be matched. As a result, the error of the average of the output voltage of the DC-DC converter for the first reference voltage can be reduced.

The above and further objects and novel features of the invention will more fully appear from the following detailed description when the same is read in connection with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a circuit diagram of a DC-DC converter 1 of the present invention;

FIG. 2 is an operation waveform diagram of the DC-DC converter when an input voltage Vin is low;

FIG. 3 is an operation waveform diagram of the DC-DC converter when the input voltage Vin is high;

FIG. 4 is a circuit diagram of a DC-DC converter 1a of a fixed period PWM control;

FIG. 5 is a circuit diagram of a DC-DC converter 1b having a SAW oscillator and a PWM voltage comparator;

FIG. 6 is a DC-DC converter 100 of a comparator system; and

FIG. 7 is an operation waveform diagram of the DC-DC converter 100.

### DETAILED DESCRIPTION OF THE PREFERRED EMBODIMENTS

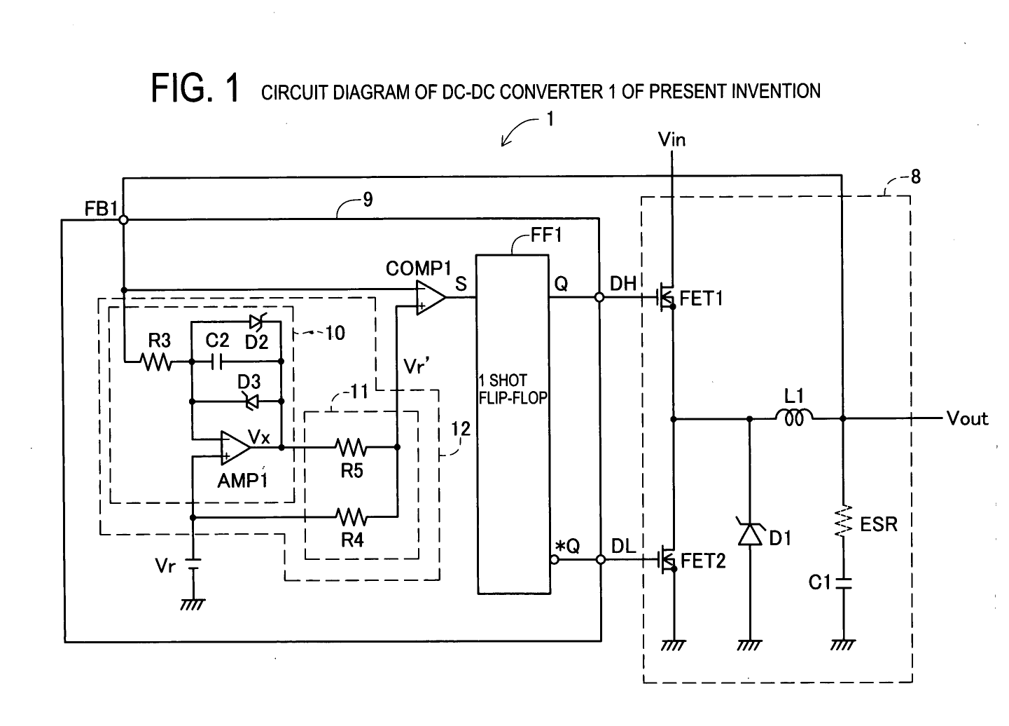

A preferred embodiment of the invention is described below referring to FIG. 1 to FIG. 3. FIG. 1 shows a DC-DC converter 1 of a comparator control system according to the invention. FIG. 1 is a circuit diagram of the DC-DC converter 1 of the present invention. The DC-DC converter 1 comprises a power unit 8 and a control unit 9.

The power unit 8 includes a transistor FET1 that is a main switching element, a transistor FET2 that is a synchronous rectifying switch circuit, a choke coil L1, a smoothing capacitor C1, and a diode D1. In FIG. 1, an input voltage Vin is connected to an input terminal of the transistor FET1, and an input terminal of the choke coil L1 is connected to an output terminal of the transistor FET1. The output terminal of the choke coil L1 is connected to an output terminal Vout of the DC-DC converter 1. An output terminal DH of the control unit 9 is connected to a control terminal of the transistor FET1. An input terminal of a transistor FET2 is connected to the ground, and an output terminal of the FET2 is connected to the input terminal of the choke coil L1. An output terminal DL of the control unit 9 is connected to a control terminal of the transistor FET2. The diode D1 is connected parallel to the transistor FET2. The smoothing capacitor C1 is connected between the output terminal of the choke coil L1 and the ground. An Output voltage Vout is issued from power unit 8. The output voltage Vout is fed into an input terminal FB1 of the control unit 9.

The control unit 9 includes an integrating circuit 12, a voltage comparator COMP1, and a one-shot flip-flop FF1. The integrating circuit 12 has an integrator 10 and an attenuator 11. The integrator 10 includes an integrating resistance R3, an integrating capacitor C2, an operational amplifier AMP1, and diodes D2 and D3. A reference voltage Vr is fed into a non-inverting input terminal of the operational amplifier AMP1. The output voltage Vout of the DC-DC converter 1 is input into an inverting input terminal of the operational amplifier AMP1 by way of the integrating resistance R3. The integrating capacitor C2 is connected between an output terminal and the inverting input terminal of the operational amplifier AMP1. The diode D3 of a normal direction from the output terminal to the inverting input terminal of the operational amplifier AMP1 is connected parallel to the integrating capacitor C2. A resistance value of the integrating resistance R3 and a capacity vale of the integrating capacitor C2 are determined so that a time constant TC of the integrator 10 may be greater than a switching period of the transistor FET1.

The attenuator 11 has resistance elements R4 and R5. The reference voltage Vr is input to an input terminal of the resistance element R4, and an output voltage Vx of the operational amplifier AMP1 is input to an input terminal of the resistance element R5. Output terminals of the resistance elements R4 and R5 are commonly connected, and are connected to a non-inverting input terminal of the voltage comparator COMP1. An adjusted reference voltage Vr′ is issued from the attenuator 11.

The input terminal FB1 of the control unit 9 is connected to the inverting input terminal of the voltage comparator COMP1, and the output terminal of the attenuator 11 is connected to the non-inverting input terminal. An output terminal of the voltage comparator COMP1 is connected to set an input terminal S of the one-shot flip-flop FF1. A non-inverting output terminal Q of the one-shot flip-flop FF1 is connected to the output terminal DH of the control unit 9, and an inverting output terminal *Q is connected to the output terminal DL of the control unit 9.

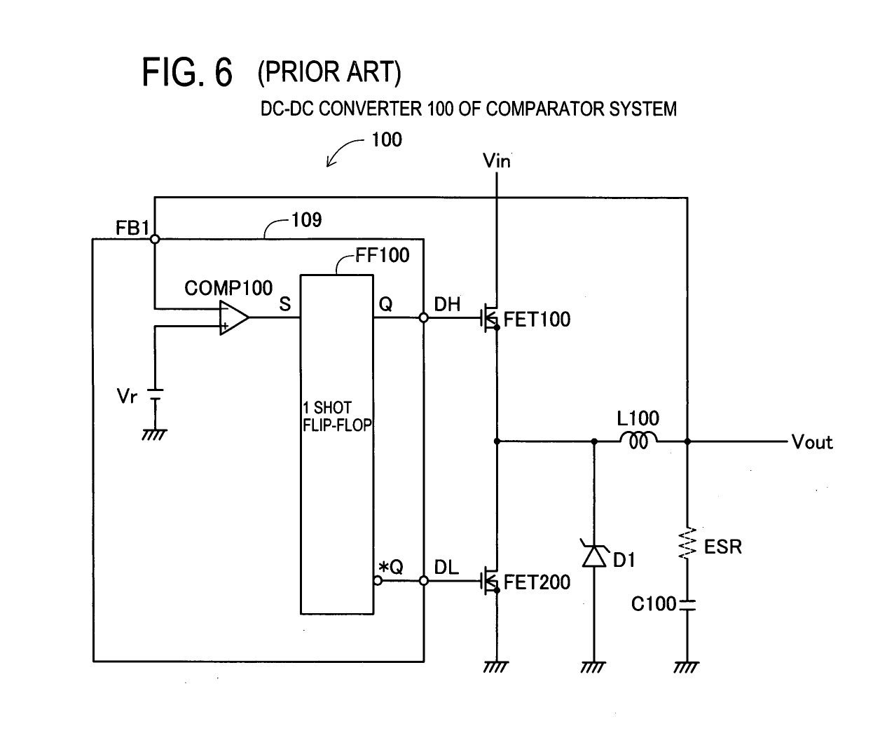

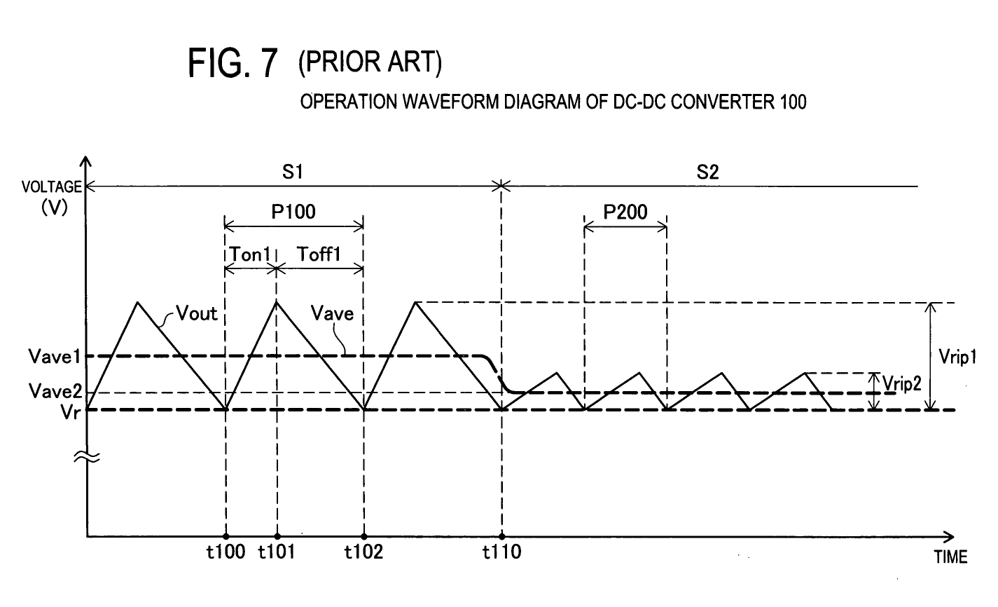

By way of comparison, an operation of a DC-DC converter 100 of a general comparator control system is explained by referring to FIG. 6 and FIG. 7. The structure of the DC-DC converter 100 shown in FIG. 6 is the same as that of the DC converter 1 shown in FIG. 1 minus the integrator 10 and the attenuator 11, and a detailed description is omitted.

An operation waveform of the DC-DC converter 100 in FIG. 6 is shown in FIG. 7. Suppose the input voltage Vin is high, being a high level input voltage VinH (a period S1). At a time t100 in the period S1 in FIG. 7, when the output voltage Vout of the DC-DC converter becomes lower than the reference voltage Vr, the voltage comparator COMP100 issues high level, and a one-shot flip-flop FF100 is set. When the one-shot flip-flop FF100 is set, a transistor FET100 is set in a conductive state, and a current is supplied into a load from the input voltage Vin by way of a choke coil L100, and the output voltage Vout of the DC-DC converter 100 elevates. As a result, a transistor FET200 is set in a non-conductive state.

When reaching a time t101 after a specified period Ton1 determined by the one-shot flip-flop FF1, the one-shot flip-flop FF100 returns to a reset state, and the transistor FET100 is in a non-conductive state, while the transistor FET200 is in a conductive state. As a result, the energy accumulated in the choke coil L100 is supplied to the load by way of the transistor FET200, but the current flowing in the choke coil 100 decreases gradually as the energy is released, and the output voltage Vout of the DC-DC converter 100 also decreases gradually. At a time t102 after a period Toff1, when the output voltage Vout of the DC-DC converter 100 becomes lower than the reference voltage Vr, the voltage comparator COMP100 issues high level, and the one-shot flip-flop FF100 returns to the set state. By repeating the period Ton1 and Toff1, ripples are generated in the output voltage.

A relation between an average output voltage Vave and the input voltage Vin is explained. In the comparator system, ripple voltage is generated generally. A maximum value of amplitude of ripple voltage based on the reference voltage Vr in the period S1 is defined as a ripple voltage amplitude value Vrip1. The ripple voltage amplitude value Vrip1 is expressed in the following formula in terms of an equivalent series resistance ESR of a smoothing capacitor C1 and current change amount ΔIL1 which is time-course change of current flowing in the choke coil L100.
Vrip1=ΔIL1×ESR formula (1)

This current change amount ΔIL1 is expressed in the following formula in terms of an inductance L of the choke coil L100 and the on-period Ton1 of the transistor FET1.
ΔIL1=(Vin−Vout)/L×Ton1 formula (2)

From the formulas (1) and (2), it is known that the amplitude of ripple voltage varies according to fluctuations of the current change amount ΔIL flowing in the choke coil L100 depending on the input voltage Vin.

Supposing there is no error in a circuit delay time of comparator or the like, an average output voltage Vave1 in the period S1 is expressed in the following formula.
Vave1=Vr+Vrip1/2 formula (3)

As known from the formula (3), the average output voltage Vave1 depends on a ripple voltage amplitude value Vrip1, and the ripple voltage amplitude value Vrip1 depends on the input voltage Vin by way of ΔIL. That is, the average output voltage Vave1 depends on the input voltage Vin. A switching period is P100.

At a time t110, suppose the input voltage Vin is low, being a low input voltage VinL (a period S2). As known from the formula (2), current change amount ΔIL2 in the period S2 is smaller than current change amount ΔIL1 in the period S1. As a result, according to the formula (3), the average output voltage Vave2 in the period S2 becomes lower than the Vave1. Hence, as shown in FIG. 7, the output voltage of the DC-DC converter 100 is lowered from the average output voltage Vave1 to Vave2. The switching period becomes shorter from P100 to P200.

That is, it is known that the average output voltage Vave depends on the ripple voltage amplitude Vrip. When an amplitude of the ripple voltage is small, the average output voltage Vave is close to the reference voltage Vr, and when it is large, the average output voltage Vave is larger than the reference voltage Vr.

Thus, in the DC-DC converter 100 of the comparator control system, an error occurs between the reference voltage Vr and the average output voltage Vave depending on the input voltage Vin or the equivalent series resistance ESR.

If a circuit delay or an offset is present in the voltage comparator COMP1, the minimum value of the output voltage Vout may not coincide with the reference voltage Vr that is a threshold voltage. As a result, an error occurs between the average output voltage Vave and the reference voltage Vr.

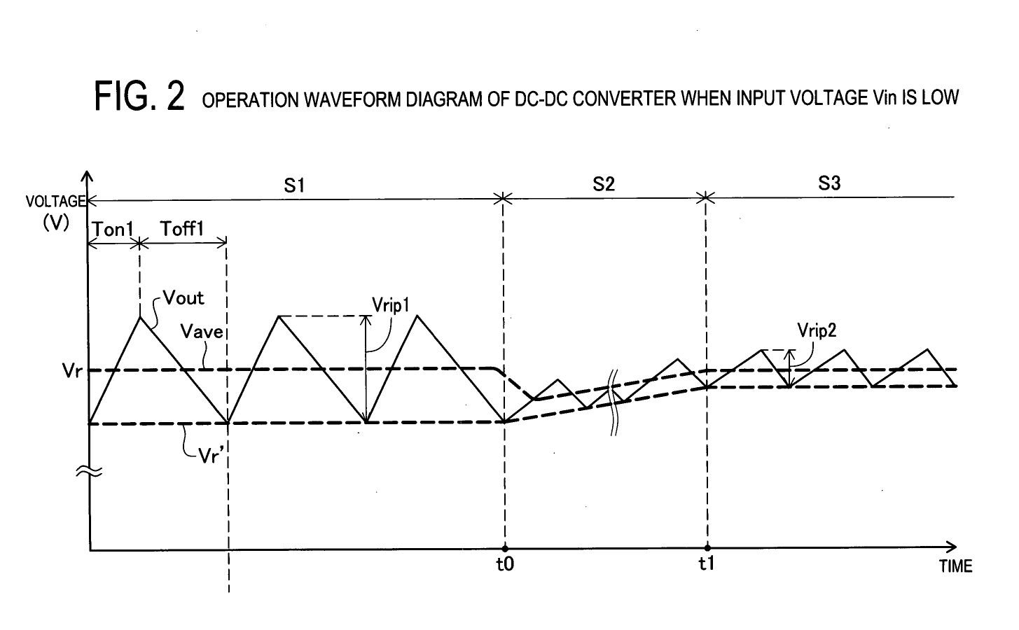

An operation of the DC-DC converter 1 of the present invention is described below referring to FIG. 1 to FIG. 3. FIG. 2 shows an operation waveform of the DC-DC converter 1 in a transition time from the high level input voltage VinH to the low level input voltage VinL.

An operation in a stationary state in the period S1 is explained. In the circuit in FIG. 1, a time constant TC (=R3×C2) of the integrator 10 is set sufficiently larger than the switching period of the transistor FET1. Hence the integrator 10 calculates the integral value of the difference between the output voltage Vout of the DC-DC converter 1 and the reference voltage Vr, and issues the output voltage Vx. The attenuator 11 attenuates the output voltage Vx as described below. The attenuated output voltage Vx and the reference voltage Vr are added, such that an adjusted reference voltage Vr′ is obtained.

In the voltage comparator COMP1, the adjusted reference voltage Vr′ is input to the non-inverting input terminal, and the output voltage Vout is input to the inverting input terminal. Hence, as shown in FIG. 2, the output voltage Vout of the DC-DC converter 1 becomes smaller than the adjusted reference voltage Vr′, and a signal of a high level is issued from the voltage comparator COMP1. In consequence, the one-shot flip-flop FF1 is put in a set state for a period of Ton1, and the transistor FET1 is set in a conductive state and the transistor FET2 in a non-conductive state, and thereby the output voltage Vout is raised. The one-shot flip-flop FF1 is put in a reset state for a period of Toff1, and the output voltage Vout descends. Thus, the period Ton1 and Toff1 are repeated alternately.

By this operation, the control unit 9 compensates the error between the average output voltage Vave of the DC-DC converter 1 and the reference voltage Vr, so that the average output voltage Vave may coincide with the reference voltage Vr, thereby controlling the value of the adjusted reference voltage Vr′ which is the threshold voltage. Hence, in the stationary state in the period S1, it is balanced so that the average output voltage Vave and the reference voltage Vr may coincide with each other.

At a time t0 in FIG. 2, in the transition time of the input voltage Vin from the high level input voltage VinH to the low level input voltage VinL, the transfer state of the average output voltage Vave and the adjusted reference voltage Vr′ is explained. Depending on the transition of the input voltage Vin, the ripple voltage amplitude Vrip is lowered from Vrip1 to Vrip2. As a result, the average output voltage Vave is lowered from Vr+(Vrip1)/2 to Vr+(Vrip2)/2, and hence the average output voltage Vave becomes lower than the reference voltage Vr.

Thus, when the average output voltage Vave is lower than the reference voltage Vr, the integrator 10 raises the output voltage Vx depending on the integral value of the difference between the average output voltage Vave and the reference voltage Vr. As a result, shown in the period S2 of FIG. 2, the adjusted reference voltage Vr′ is elevated. Hence, at the time t1, it is compensated so that the average output voltage Vave may coincide with the reference voltage Vr. In a period S3 after the time t1, it is balanced to keep coincidence with the average output voltage Vave and the reference voltage Vr, thereby settling in a stationary state.

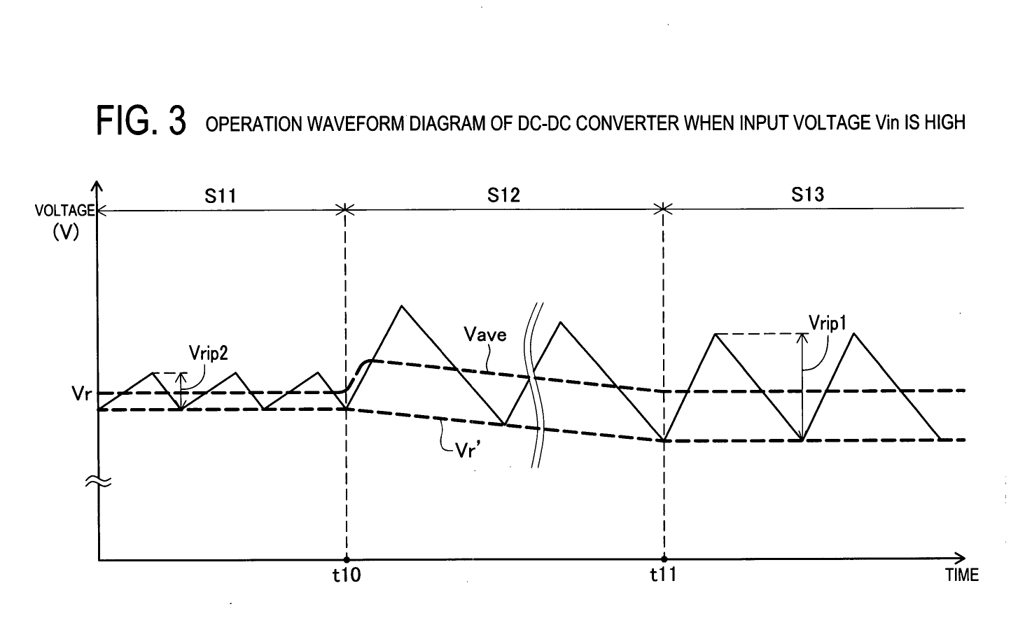

FIG. 3 shows an operation waveform of the DC-DC converter 1 when changing from the low level input voltage VinL to the high level input voltage VinH. An operation in a stationary state in a period S11 is explained. In the period S11, as mentioned above, the control unit 9 compensates for an error between the average output voltage Vave of the DC-DC converter 1 and the reference voltage Vr, and controls the value of the adjusted reference voltage Vr′, which is the threshold voltage so that the average output voltage Vave may coincide with the reference voltage Vr. Hence, in the period S11, it is balanced so that the average output voltage Vave may coincide with the reference voltage Vr.

At a time t10 in FIG. 3, when the input voltage Vin is changed from the low level input voltage VinL to the high level input voltage VinH, the ripple voltage amplitude value Vrip increases from Vrip2 to Vrip1. As a result, the average output voltage Vave elevates according to the formula (3), and the average output voltage Vave becomes higher than the reference voltage Vr. Thus, when the average output voltage Vave is higher than the reference voltage Vr, the integrator 10 operates to lower the adjusted reference voltage Vr′ depending on the integral value of the difference between the average output voltage Vave and the reference voltage Vr (a period S12 of FIG. 3). As a result, at a time t11, it is compensated so that the average output voltage Vave may coincide with the reference voltage Vr. In a period S13 after the time t11, it is balanced so that the average output voltage Vave may coincide with the reference voltage Vr, and the stationary state is maintained.

If a circuit delay or an offset is present in the voltage comparator COMP1, the control unit 9 compensates so that the average output voltage Vave may coincide with the reference voltage Vr. Therefore, the average output voltage Vave and the reference voltage Vr may coincide with each other without effect of a circuit delay or an offset.

An action of the diodes D2 and D3 is explained. The diodes D2 and D3 connected parallel to the integrating capacitor C2 work as clamp circuits for suppressing the output voltage Vx of the operational amplifier AMP1 within a specified value.

At the time of starting of the DC-DC converter 1 or load short-circuiting, when a value of the output voltage Vout changes to a very low value as compared with the reference voltage Vr, the output voltage Vx of the operational amplifier AMP1 becomes the maximum value. At this time, when the output voltage Vx is directly input to the voltage comparator COMP1, since a gain of the integrator 10 is high, a response of the feedback of DC-DC converter 1 becomes higher than required. As a result, it may take a longer time for convergence until both the average output voltage Vave and the reference voltage Vr are matched when controlling the value of the adjusted reference voltage Vr′ so that the average output voltage Vave and the reference voltage Vr may be equal to each other. Hence, by providing the diode D3, the value of the output voltage Vx may be clamped at the offset value of the diode D3, and hence the output value Vx can be suppressed within a specific value. The value of the offset voltage is, for example, 0.7 V.

Similarly, at the time of stopping of a load or the like, the value of the output voltage Vout is changed to a higher value than the reference voltage Vr, the output voltage Vx of the operational amplifier AMP1 becomes the minimum value. At this time, too, since a gain of the integrator 10 is high, it may take a longer time for convergence for adjusting the adjusted reference voltage Vr′ so that the average output voltage Vave and the reference voltage Vr may be equal to each other. Hence, by using the diode D2, a value of the output voltage Vx may be clamped at an offset value of the diode D2, and hence the output value Vx can be suppressed within a specific value.

Thus, by providng the diodes D2, D3, at the time of starting of the DC-DC converter 1 or load short-circuiting, a malfunction of the control unit 9 can be prevented when the value of the output voltage Vout is extremely out of the reference voltage Vr. Hence at the time of fluctuations of the output voltage Vout, a convergence time can be shortened until the error between the average output voltage Vave of the DC-DC converter 1 and the reference voltage Vout is compensated and the both are matched. It is noted that compensation is performed only for drop of the output voltage Vout. When compensation is not required for an elevation of the output voltage Vout, only the diode D3 is used, and the diode D2 is eliminated, such that the circuit structure of the integrator 10 may be simplified.

An action of the attenuator 11 is explained. In the case where the integrator 10 is provided with the diodes D2 and D3 as clamp circuits, an output gain of the integrator 10 may be large. In this case, a feedback response of the DC-DC converter 1 may be faster than required, and it may take a longer time for convergence for adjusting the adjusted reference voltage Vr′ so that the average output voltage Vave and the reference voltage Vr may be equal to each other. Hence, the attenuator 11 is used for further attenuating an output gain of the integrator 10.

The attenuator 11 adds the integral value, obtained by the integrator 10, of the difference between the output voltage Vout and the reference voltage Vr, to the reference voltage Vr to obtain the adjusted reference voltage Vr′. The following formula (4) is established in the attenuator 11.
Vr′=(Vx×R4+Vr×R5)/(R4+R5) formula (4)
That is, the output voltage Vx is divided into R4/(R4+R5) and attenuated, and the reference voltage Vr is divided into R5/(R4+R5) and attenuated. By adding the attenuated output voltage Vx to the attenuated reference voltage Vr, the adjusted reference voltage Vr′ is obtained.

Herein, the output voltage Vx has an action of adjusting the value of the adjusted reference voltage Vr′, depending on the amplitude of the ripple voltage. Hence, the amplitude of the output voltage Vx is enough as far as the value which can correspond to the maximum ripple width of the ripple voltage generated in the output voltage can be preserved. Hence, depending on the maximum ripple width of the ripple voltage, an attenuation ratio of the output voltage Vx and the reference voltage Vr can be determined.

Generally, since the amplitude of the ripple voltage is sufficiently smaller than the reference voltage Vr, the output amplitude of the output voltage Vx must be attenuated by more than the reference voltage Vr. Hence, if the integrator 10 is not provided with diodes D2, D3, an output amplitude of the output voltage Vx of the operational amplifier AMP1 may be attenuated by one-several tenths. For example, when the integrator 10 has the diodes D2, D3, the output amplitude of the output voltage Vx can be suppressed somewhat by the diodes, and the output amplitude of the output voltage Vx may be attenuated to only about one-tenth. Hence, depending on the degree of the attenuation of the output amplitude of the output voltage Vx, the resistance value of resistance element is so set as to be ten times to tens of times of the resistance element R4.

Accordingly, if the clamp amount by the diodes D2, D3 is small, by using the attenuator 11, the output voltage Vx can be suppressed within a narrow range. Hence, by providing the attenuator 11, at the time of the start of the DC-DC converter 1 or the load short-circuiting, it is effective to prevent the malfunction of the control unit 9 in a state of the output voltage Vout extremely out of the reference voltage Vr.

As described specifically herein, the control unit 9 of the DC-DC converter 1 of the present embodiment can reduce the error generated between the reference voltage Vr and the output voltage Vout, depending on the input voltage Vin or equivalent series resistance ESR. Accordingly, the average output voltage Vave can be set closer to the reference voltage Vr, so that the accurate output voltage Vout may be obtained.

Even if a circuit delay or an offset is present in the voltage comparator COMP1, the control unit 9 compensates so that the average output voltage Vave may coincide with the reference voltage Vr. Therefore, the average output voltage Vave coinciding with the reference voltage Vr can be obtained.

Moreover, by the diodes D2 and D3, and the attenuator 11, an amplitude of the output voltage Vx of the operational amplifier AMP1 can be suppressed. As a result, an error between the average output voltage Vave of the DC-DC converter 1 and the reference voltage Vr can be compensated, and the convergence time until both are matched can be shortened.

The present invention is not limited to the foregoing embodiment alone, but may be changed and modified within a scope not departing from the true spirit of the present invention.

The integrating circuit 12 in FIG. 1 has the attenuator 11, but it is not limited to this embodiment alone. Without using the attenuator 11, the output voltage Vx of the operational amplifier AMP1 may be fed into the voltage comparator COMP1. In this case, too, the error between average output voltage Vave of the DC-DC converter 1 and the reference voltage Vr can be compensated, and the value of the output voltage Vx as the threshold voltage can be controlled so that the average output voltage Vave may coincide with the reference voltage Vr.

The integrator 10 has the diodes D2 and D3, but the present invention is not limited to this embodiment. The diodes D2 and D3 can be omitted if the amplitude of the output voltage Vx of the attenuator 11 can be sufficiently suppressed, and the convergence time can be shorted when adjusting the adjusted reference voltage Vr′ so that the average output voltage Vave may be equal to the reference voltage Vr, and thereby the circuit can be simplified. When the integrating capacitor C2 can be realized in a junction capacity by an integrated circuit, the integrated capacitor C2 and the diode D3 can be fabricated as an integrated element. As a result, the circuit can be also simplified.

In the present invention, the DC-DC converter 1 of a synchronous rectifying system is explained by referring to FIG. 1, but it is not limited to this mode. For example, it may be realized, by a DC-DC converter of a non-synchronous rectifying system not having the transistor FET2, the output terminal DL and the inverting output terminal *Q in FIG. 1. In this case, too, needless to say, an error between the average output voltage Vave and the reference voltage Vr is compensated.

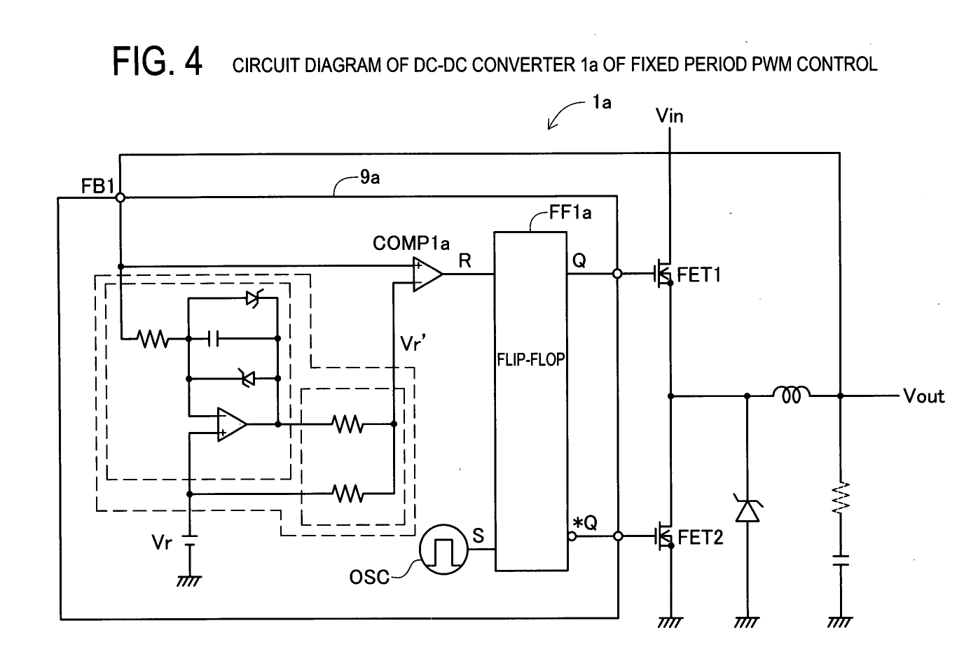

In the present invention, the DC-DC converter 1 of a fixed on-time control is explained by referring to FIG. 1, but it is not limited to this mode. For example, it may be realized by a DC-DC converter 1a of a fixed period PWM control as shown in FIG. 4. The control unit 9a has a flip-flop FF1a, an oscillator OSC, and a voltage comparator COMP1a. The adjusted reference voltage Vr′ is input to the inverting input terminal of the voltage comparator COMP1a, and the output voltage Vout is input to the non-inverting input terminal. The output terminal of the voltage comparator COMP1a is connected to a reset terminal R of a flip-flop FF1a, and the output terminal of the oscillator OSC is connected to a set input terminal S. Another structure is the same as that of the control unit 9 in FIG. 1, and a detailed description is omitted.

The oscillator OSC puts the flip-flop FF1a in a set state in every specified period. Hence the transistor FET1 is set in a conductive state in every specified period. The voltage comparator COMP1a sets the transistor FET1 in a non-conductive state as the output voltage Vout of the DC-DC converter 1a becomes larger than the adjusted reference voltage Vr′. As a result, also in the DC-DC converter 1a of the fixed period PWM control, an error between the average output voltage Vave and the reference voltage is compensated, and the average output voltage Vave coincides with the reference voltage Vr, thereby controlling the value of the adjusted reference voltage Vr′, that is, a threshold voltage.

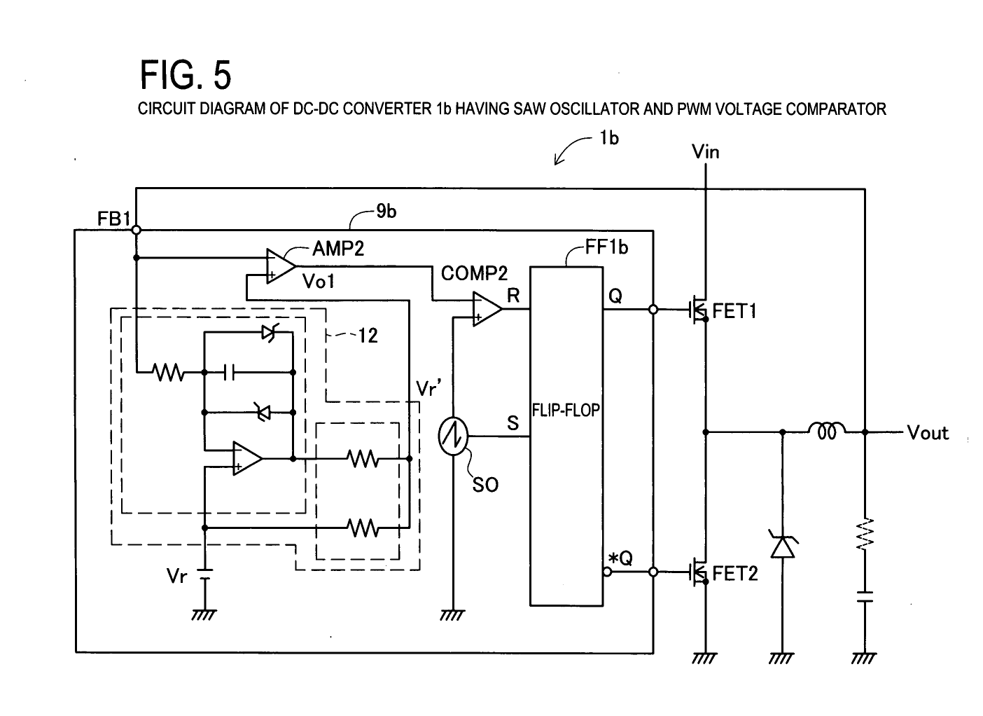

In the present invention, the DC-DC converter 1 of a fixed on-time control is explained by referring to the circuit in FIG. 1, but it is not limited to this mode. For example, as shown in FIG. 5, the present invention can be also applied to the DC-DC converter 1b controlled by a SAW (surface acoustic wave) oscillator and a PWM voltage comparator. The control unit 9b has a flip-flop FF1b, a SAW oscillator SO, a direct-current amplifier AMP2, and a PWM voltage comparator COMP2. The adjusted reference voltage Vr′ is input to the non-inverting input terminal of the direct-current amplifier AMP2, and the output voltage Vout is input to the inverting input terminal. The direct-current amplifier AMP2 is a fixed gain wideband amplifier. The output terminal of the direct-current amplifier AMP2 is connected to the inverting input terminal of the PWM voltage comparator COMP2, and the output terminal of the SAW oscillator SO is connected to the non-inverting input terminal of the PWM voltage comparator COMP2. The output terminal of the PWM voltage comparator COMP2 is connected to the reset terminal R of the flip-flop FF1a. The output terminal of the SAW oscillator SO is connected to the set input terminal S of the flip-flop FF1a. Another structure is the same as that of the control unit 9 in FIG. 1, and a detailed description is omitted.

The SAW oscillator SO puts the flip-flop FF1b in a set state in every specified period, and sets the transistor FET1 in a conductive state in every specified period. The direct-current amplifier AMP2 amplifies a differential voltage of the adjusted reference voltage Vr′ and the output voltage Vout without depending on the frequency characteristic of the output voltage Vout, and outputs an output voltage Vo1. In the PWM voltage comparator COMP2, the flip-flop FF1b is put in a reset state as the output voltage of the SAW oscillator SO becomes larger than the output voltage Vo1 of the direct-current amplifier AMP2, and thereby the transistor FET1 is set in a non-conductive state. Hence, as the output voltage Vout of the DC-DC converter 1b becomes smaller than the adjusted reference voltage Vr′, the transistor FET1 is set in a non-conductive state. That is, the peak value of the output voltage Vout is controlled by the adjusted reference voltage Vr′.

The integrating circuit 12 lowers the adjusted reference voltage Vr′ depending on the integral value of the difference between the average output voltage Vave and the reference voltage Vr when the value of the input voltage Vin is low, and elevates the adjusted reference voltage Vr′ depending on the integral value of the difference between the average output voltage Vave and the reference voltage Vr when the value of the input voltage Vin is high. By this operation, the control unit 9b compensates for an error between the average output voltage Vave of the DC-DC converter 1b and the reference voltage Vr, and controls the value of the adjusted reference value Vr′ which is the threshold voltage so that the average output voltage Vave may coincide with the reference voltage Vr. It thereby causes to decrease the error due to the input voltage Vin and error due to a circuit delay or an offset existing in the PWM voltage comparator COMP2 occurring between the reference voltage Vr and the output voltage Vout.

Input to the input terminal of the resistance element R4 is not limited to the reference voltage Vr. For example, the input may be a grounding potential, and in this case, too, the output voltage Vx can be attenuated or a second reference voltage different from the reference voltage Vr may be also supplied.

The present invention refers to the step-down DC-DC converter 1, but is not limited to this mode. Using the transistor FET2 as a main switching transistor, the transistor FET1 can be used as a synchronous rectifying switch circuit, the present invention can be applied in the step-up DC-DC converter.

The present reference voltage Vr is an example of the first reference voltage, the integrating resistance R3 is an example of the first resistance element, the resistance element R4 is an example of the second resistance element, the resistance element R5 is an example of the third resistance element, the diode D3 is an example of the first diode, and diode D2 is an example of the second diode.

According to the control circuit and the control method of the DC-DC converter described herein, the present invention can decrease errors between the output voltage and the reference voltage due to fluctuations of the input voltage and the offset voltage and the circuit delay time of the voltage comparator, and can respond to a sudden load changed rapidly.

What is claimed is:

1. A control circuit of a DC-DC converter of a switching regulator system for generating an output voltage depending on a first reference voltage from an input voltage, comprising:
an integrating circuit for determining an integral value of a differential voltage of the output voltage of the DC-DC converter and the first reference voltage,
wherein a main switching transistor is controlled depending on a comparison result of the output voltage of the DC-DC converter and an output voltage of the integrating circuit.

2. The control circuit of the DC-DC converter of claim 1, wherein the integrating circuit comprises:
a first operational amplifier for receiving the output voltage of the DC-DC converter at an inverting input terminal, and receiving the first reference voltage at a non-inverting input terminal,
a capacitor provided on a connection route of an output terminal of the first operational amplifier and the inverting input terminal of the first operational amplifier, and
a first resistance element for receiving the output voltage of the DC-DC converter at one end, with the other end connected to the inverting input terminal of the first operational amplifier.

3. The control circuit of the DC-DC converter of claim 2, wherein a time constant determined by the capacitor and the first resistance element is set larger than a switching period of the main switching transistor.

4. The control circuit of the DC-DC converter of claim 2, further comprising a first diode connected parallel to the capacitor in a forward direction from the output terminal of the first operational amplifier to the inverting input terminal of the first operational amplifier.

5. The control circuit of the DC-DC converter of claim 2, further comprising a second diode connected parallel to the capacitor in a forward direction from the inverting input terminal of the first operational amplifier to the output terminal of the first operational amplifier.

6. The control circuit of the DC-DC converter of claim 2, wherein the integrating circuit includes:
an attenuator for attenuating an output voltage of the first operational amplifier and outputting the attenuated voltage.

7. The control circuit of the DC-DC converter of claim 6, wherein the attenuator comprises:
a second resistance element receiving a second reference voltage at an input terminal, and
a third resistance element having a larger resistance value than the second resistance element, receiving the output voltage of the first operational amplifier at an input terminal, with the output terminal connected commonly with the output terminal of the second resistance element.

8. The control circuit of the DC-DC converter of claim 7, wherein the second reference voltage is equal to the first reference voltage.

9. The control circuit of the DC-DC converter of claim 1, further comprising:
a comparator for receiving the output of the DC-DC converter at an inverting input terminal and receiving the output of the integrating circuit at a non-inverting input terminal,
wherein the main switching transistor is controlled to be set in a conductive state as the output of the DC-DC converter becomes smaller than the output of the integrating circuit.

10. The control circuit of the DC-DC converter of claim 1, further comprising:
a second operational amplifier for receiving the output of the DC-DC converter at an inverting input terminal and receiving the output of the integrating circuit at a non-inverting input terminal,
a surface acoustic wave oscillator, and
a PWM comparator for receiving the output of the second operational amplifier at an inverting input terminal and receiving the output of the surface acoustic wave oscillator at a non-inverting input terminal,
wherein the main switching transistor is controlled to be set in a non-conductive state as the output of the DC-DC converter becomes larger than the output of the integrating circuit.

11. A control method of a DC-DC converter in a DC-DC converter of a switching regulator system for generating an output voltage depending on a first reference voltage from an input voltage, comprising the steps of:
a step of determining an integral value of voltage difference between the output voltage of the DC-DC converter and the first reference voltage, and
a step of controlling a main switching transistor depending on a comparison result of the output voltage of the DC-DC converter and an output voltage depending on the integral value.
